(19) United States
(12) Patent Application Publication
(10) Pub. No.: US 2008/0308691 A1
(43) Pub. Date: Dec. 18, 2008

(54) Height adjustable table leg

(76) Inventor: Dwight Stanley Greer, (US)

Correspondence Address: Dwight S. Greer, 33870 S. Wilhoit Rd., Molalla, OR, 97038, US

(21) Appl. No.: 12/157,783

(22) Filed: Jun. 12, 2008

Related U.S. Application Data
(60) Provisional application No. 60/943,526, filed on Jun. 12, 2007.

(51) Int. Cl. F16M 11/24

(52) U.S. Cl. 248/188.4

(57) ABSTRACT

A height-adjustable table leg includes an elongate member having a number of grooves placed along the length of the member at predetermined distances, and a mounting bracket that connects at one end to the underside of the table plane, along with a circumscribing member connected to that mounting bracket at the opposite end thereof and sized and shaped to surround the leg at a selected one of those grooves, with that circumscribing member also having a hook-like member rotatably connected thereto that can be rotated towards the leg so as to hold that circumscribing member in place within a selected one of those grooves. Upon selecting a particular one of those grooves into which that circumscribing member will be placed, the effective length of each of such legs attached to the underside of a table or like work surface can be adjusted, thus to place that surface at a desired height above the surface on which the legs of the table stand.

### BACKGROUND OF THE INVENTION

Work surfaces or tables are commonly mounted on legs to support the work surface at a convenient height. In many applications it is desirable that the height be adjustable to suit the workman or any equipment used in conjunction with the work surface as well as, in multiple leg applications, to allow the leveling of the work surface by compensating for an uneven floor or other similar conditions. Such legs frequently consist of overlapping or telescoping components that can be secured in relationship to one another to provide a variable length to the leg. In most applications, the table is of a height in excess of 24″ in order to be used by a sitting or standing person. Consequently, there is considerable space for adjusting and locking mechanisms. This available space also allows for the two or more overlapping or telescoping components to have a substantial length of engagement in order to provide good axial rigidity. A common method of length adjustment is a simple screw thread to allow one component to thread in or out of the second component. An example of this method can be found in in U.S. Pat. No. 6,874,430 which describes the construction of adjustable extension tables for tabletop mounted sewing machines and utilizes a conventional thread adjustable foot to support the table and allow for adjustment to different height sewing machines. This method is generally used for small ranges of adjustment such as in leveling applications since adjustment over longer ranges of height would be time consuming. It has the advantage of being fairly positive and allowing fine increments of adjustment although such adjustments aren't readily repeatable without trial and error or by the use of measuring tools should the leg need to be frequently adjusted between two or more commonly used settings. Also common are legs wherein the height adjustment is secured by means of a friction clamping mechanism such as a set screw or collet that is mounted on one component and, when tightened, bears against the second component to lock it in relationship at the desired position. Such legs are generally quick to adjust but often have the disadvantage of slipping out of adjustment if heavier loads are applied to the work surface. They also share the disadvantage of not allowing easily repeatable adjustments.

### BACKGROUND INFORMATION

One example of prior art in the construction of adjustable extension tables for tabletop mounted sewing machines is found in U.S. Pat. No. 6,874,430 which utilizes a conventional thread adjustable foot to support the table and allow for adjustment to different height sewing machines, An example of the notch type locking mechanism is found in U.S. Pat. No. 1,549,144 wherein the adjustable portion contains a series of notches along its length and the stationary portion of the leg contains a locking mechanism to engage said notches.

A variation on this theme is found in U.S. Pat. No. 5,899,422 wherein a series of annular fins on a male member engage a series of annular grooves in a female member and the male member can be rotated such that clearances on both members allow longitudinal movement and thereby length adjustment. The length is set by rotating the clearances out of alignment and retaining this relationship with a clamp screw. This method is limited to coarse adjustments as the pitch of the engaging annular grooves and fins must be of sufficient size to retain adequate strength.

An example of removable rigid legs for a low support surface can be found in U.S. Pat. No. 5,368,266. While compact and sturdy, this method does not allow quick adjustment without additional parts.

Another common method of leg height adjustment has one component that contain a series of notches, holes, or other features arrayed along its length. A second component would then have a mechanism to engage one of these notches and the overall length of the leg could be altered by selecting which notch to engage. An example of the notch type locking mechanism is found in U.S. Pat. No. 1,549,144 wherein the adjustable portion contains a series of notches along its length and the stationary portion of the leg contains a locking mechanism to engage said notches. As was noted, such methods generally require a substantial amount of space for both the locking mechanism and especially for the overlap engagement between components to maintain rigidity. As a result, the maximum attainable height of the leg will be the length of the two adjusting components minus the amount of overlap between the two components and minus any space required by the locking mechanism. In most applications of table legs, the necessary range of adjustment is only a small portion of the overall length so there is adequate space available for the overlap of the components. A variation on this theme is found in U.S. Pat. No. 5,899,422 wherein a series of annular fins on a male member engage a series of annular grooves in a female member and the male member can be rotated such that clearances on both members allow longitudinal movement and thereby length adjustment. The length is set by rotating the clearances out of alignment and retaining this relationship with a clamp screw. This method is limited to coarse adjustments as the spacing of the engaging annular grooves and fins must be of sufficient size to retain adequate strength.

On applications where the height of the table is low and space for the above mentioned methods is unavailable, adjustability is sometimes obtained through the use of rigid replaceable leg inserts of assorted heights. While simple, this method requires a large number of inserts to provide a range of adjustment. An example of removable rigid legs for a low support surface can be found in U.S. Pat. No. 5,368,266. While compact and sturdy, this method does not allow quick adjustment without additional parts.

There are applications where the maximum height of the table is low and the need for repeatability and range of adjustment as well as ease of adjustment are not well suited to the above mentioned methods.

One such application is in the construction of adjustable extension tables for tabletop mounted sewing machines. A sewing extension table provides a large flat work surface around a sewing machine at the height of the stitching portion of the sewing machine, giving a portable sewing machine a large work surface similar to a cabinet mounted sewing machine but without the cost and bulk of a cabinet mounted sewing machine. Since portable sewing machines come in an ever-changing variety of sizes and shapes, it is desirable that an extension table designed for such machines be adjustable to fit machines of a variety of heights. Since such a table may be frequently moved between different sewing machines, it is desirable that the height adjustment be both quick and repeatable, making threaded type adjustments unsuitable. Due to the wide range of heights found in such machines, there is very little room for overlap between the two members of an adjustable leg. A telescoping leg that can adjust tall enough for the taller machines can have very little overlap between the adjusting parts if the parts are to be short enough to still allow room for them when adjusted for the shortest machines. A third height adjusting member could be added to keep the height of the individual pieces short enough but has the undesirable effect of adding cost and complexity. Additionally, an adjustment retained by other means such as clamp screws are prone to slippage and marring of the clamped parts as well as requiring greater overlap of the adjusting parts to give rigidity. The room taken by the overlap must be subtracted from the overall range of adjustment.

### FIELD OF THE INVENTION

The present invention relates to a quick height-adjustable, accurately repeatable, sturdy leg with wide range of adjustment for use on low tables and work surfaces.

### BRIEF SUMMARY OF THE INVENTION

An adjustable-height leg assembly for use on low tables or work surfaces consisting of a leg with a series of annular grooves through the extent of its length, a mounting bracket for attaching to the table or work surface able to engage said annular grooves to provide an incremental series of options for overall length wherein the minimum overall length is nearly equal to half of the maximum overall length, and a locking or latching device for retaining said leg in the desired relationship with said mounting bracket.

### NUMBERING OF ELEMENTS

1 Adjustable leg assembly, round leg with lever lock
2 Mounting bracket for round leg and lever lock
3 Leg, round cross-section with annular grooves
4 Lock
5 Rubber stem bumper
6 Annular grooves
7 Mounting hole
20 Adjustable leg assembly, round leg with rotating lock
21 Mounting bracket for round leg and rotating lock
22 Rotating lock
23 Clearance flat on rotating lock
24 Rubber grommet/retainer
30 Adjustable leg assembly, polygonal leg with straddle lock
31 Mounting bracket for polygonal leg with straddle lock
32 Polygonal cross-section leg with annular grooves
33 Straddle lock
40 Adjustable leg assembly, polygonal leg with sliding lock
41 Mounting bracket for polygonal leg with sliding lock
42 42 Sliding lock

### BRIEF DESCRIPTION OF THE DRAWINGS

FIG. 1

Adjustable leg assembly, round leg with lever lock

FIG. 2

Adjustable leg assembly installed in a low support table or work table.

FIG. 3

Displays a typical application for the adjustable leg assembly on adjustable sewing machine extension table.

FIG. 4

Showing how the leg may be used to adjust the surface table to match the height of the sewing machine.

FIG. 5

The table shown with the adjustable legs set to a minimum adjustable height, dimension (A).

FIG. 6

The table shown with the adjustable legs set to a maximum adjustable height, dimension (B).

FIG. 7

The table shown with the adjustable leg completely removed from mounting bracket

FIG. 8

Profile view of the adjustable leg assembly (1), round leg with lever lock.

FIG. 9

Face view of the adjustable leg assembly (1), round leg with lever lock.

FIG. 10

Oblique view of the adjustable leg assembly (1), round leg with lever lock.

FIG. 11

View of the adjustable leg assembly (1) showing the alternate unlocked position of the lever lock (4) and the direction of removal of the leg (3) to allow for adjustment.

FIG. 12

A view of the adjustable leg assembly (1) with the lever lock (4) in the unlocked position and the leg (3) removed for adjustment.

FIG. 13

A view showing the adjustable leg assembly (1) with the leg (3) inserted into the slot of leg.

FIG. 14

Detail of the leg (2).

FIG. 15

Shows a profile view of assembly (1) with the “C” portion of the leg oriented down.

FIG. 16

Shows a profile view of assembly (1) with the “B” portion of the leg oriented down.

FIG. 17

Shows the bracket (2) with leg (3) completely removed.

FIG. 18

A face view of adjustable leg assembly, round leg with rotating lock (20).

FIG. 19

A profile view of adjustable leg assembly, round leg with rotating lock (20)

FIG. 20

A view showing the leg (3) retained in the leg bracket (21) on an annular groove by the rotating lock (22).

FIG. 21

A view showing the rotating lock (22) rotated such that the clearance flat (23) is parallel with the slot in the leg bracket (21)

FIG. 22

A view showing the leg (3) having been re-inserted into the leg bracket (21) utilizing a different annular groove to achieve a different leg height.

FIG. 23

A view showing the relationship between the rotating lock (22), the clearance flat (23) and the leg (3) when in the locked condition.

FIG. 24

A view showing the relationship between the rotating lock (22), the clearance flat (23) and the leg (3) when in the unlocked condition.

FIG. 25

A view showing an alternate method of construction (30) wherein a polygonal leg (32) with a series of annular grooves is mounted in a leg bracket (31) that has a like shaped polygonal hole in it.

FIG. 26

A view showing the alternate method (30) as in FIG. 25 with the straddle lock (33) raised to it's disengaged position and the leg (32) rotated into time with the polygonal hole and removed from the bracket.

FIG. 27

A top view to show the out-of-time relationship between the polygonal leg (32) and the polygonal hole in the bracket (31).

FIG. 28

A top view showing the straddle lock raised to it's disengaged position and the polygonal features of the leg (32) rotated into time with the corresponding features of the hole in the bracket (31).

FIGS. 29 through 32 show the sequence of readjusting to a different height as applied to the adjustable leg assembly (30).

FIG. 29

A side view showing the leg assembly (30) at a selected height.

FIG. 30

A side view showing the straddle lock (33) raised to the disengaged position and the polygonal leg (32) rotated into time with the bracket (31).

FIG. 31

A view showing the leg (32) completely removed for re-adjustment.

FIG. 32

A view showing the leg (32) re-installed into the bracket (31) at a new height setting, rotated out of time with the polygonal hole, and the straddle lock (33) re-engaged to retain the new setting.

FIG. 33

A view showing an alternate method of construction (40) wherein a polygonal leg (32) with a series of annular grooves is mounted in a leg bracket (41) that has a like shaped polygonal hole in it

FIG. 34

A view showing an alternate method of construction (40) wherein a polygonal leg (32) with a series of annular grooves is mounted in a leg bracket (41) that has a like shaped polygonal hole in it. The sliding lock (43) locking device is disengaged with the sides of the polygon to allow rotation.

FIG. 35

A profile view of (40) showing the leg (32) engaged with the bracket (41) via an annular groove and the sliding lock (33) engaged to prevent rotation of the leg (32).

FIG. 36

A bottom view showing the out-of-time condition of the leg (32) relative to the bracket (41) and the slide lock (33) engaged against one of the flats of the polygonal leg (32).

FIGS. 37 through 40 show the sequence of readjusting to a different height as applied to the adjustable leg assembly (40).

FIG. 37

A view showing the initial condition of the leg (32) rotated into the locked condition and the sliding lock (43) pressed down to engage a flat to prevent rotation.

FIG. 38

A view showing the sliding lock (43) in the raised and unlocked condition with the leg (32) rotated preparatory to adjusting

FIG. 39

A view showing the leg (32) completely removed for re-adjustment and the sliding lock (43) in the raised and disengaged position.

FIG. 40

A view showing the leg (32) re-installed into the bracket (41) at a new height setting, rotated out of time with the polygonal hole, and the sliding lock (43) re-engaged to retain the new setting.

### DESCRIPTION OF A PREFERRED EMBODIMENT OF THE INVENTION

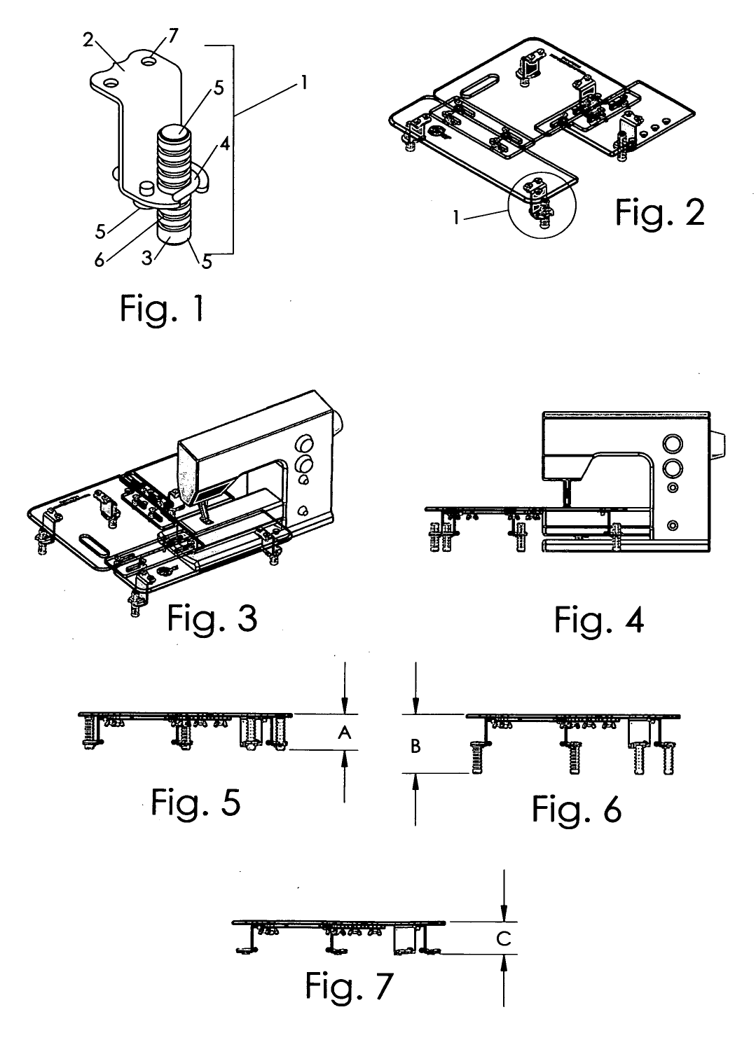

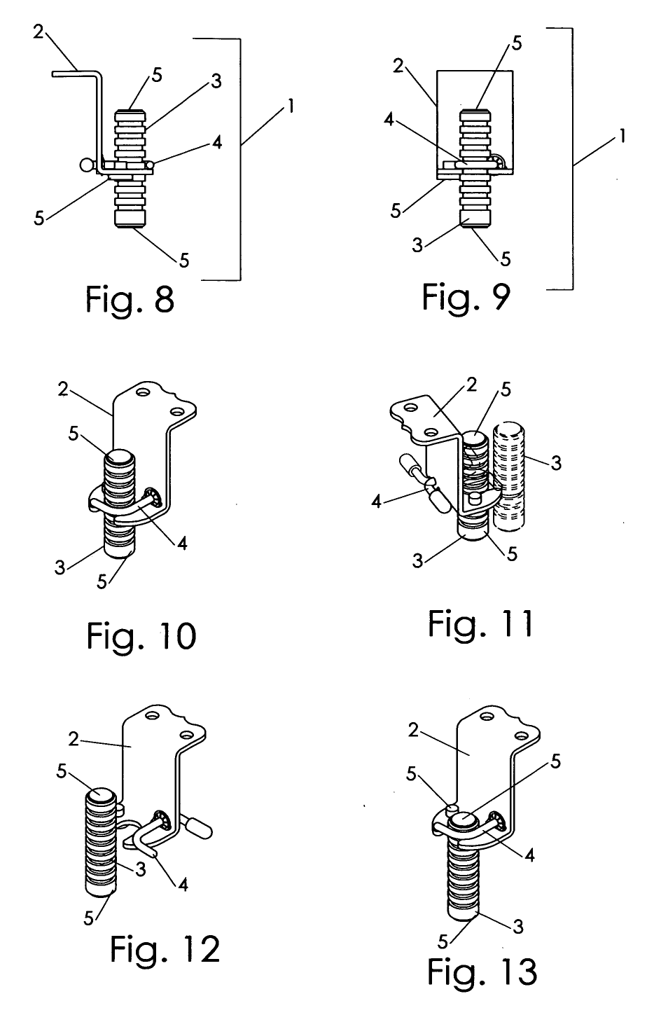

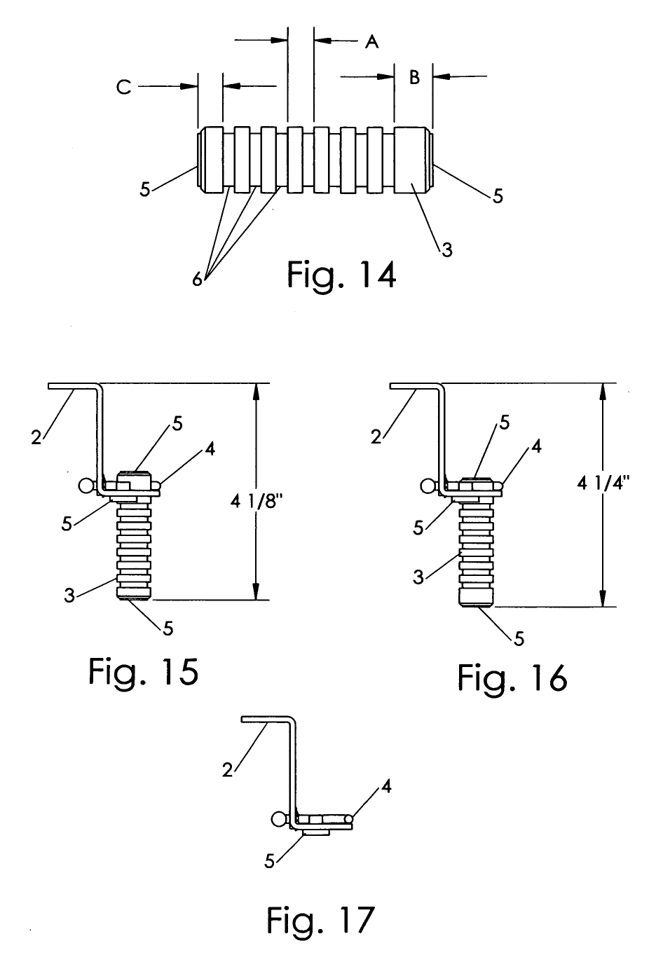

In one embodiment as shown in FIG. 1 and further shown in FIGS. 8,9, and 10, the leg assembly (1) consists of a leg (3) comprised of a cylindrical section. Interspersed at regular intervals of dimension “A” as shown in FIG. 14, along the length of leg (3) is a series of annular grooves (6) distributed throughout most of its length. The leg (3) may also contain a rubber stem bumper (5) or other soft material in each end to prevent marring of a surface the leg assembly (1) may rest on as well as prevent sliding of the leg assembly (1) on said surface. The rubber stem bumpers (5) may be mounted on both ends of the leg (3) to permit either end of the leg to serve as the foot of the leg

A mounting bracket (2) optionally engages one of the annular grooves (6) of leg (3) and provides a point for connecting the leg assembly (1) to a low table or other surface by way of bolts or screws through mounting hole(s) (7) as shown in FIG. 2. The mounting bracket (2) is a generally “L” shaped bracket wherein the lower horizontal leg of the “L” contains a slot, fork, or hole of similar cross-section to the leg (3) that may engage one at a time any of the annular grooves (6) in the leg in differing selectable positions thereby creating selectable overall heights for the leg assembly (1). The lower portion of mounting bracket (2) may also contain a rubber stem bumper (5) to allow the leg (3) to be removed altogether and allow the bracket alone to serve as a fixed height leg in very short applications while retaining the non-marring and non-slipping properties. The upper portion of the mounting bracket (2) provides a flat surface and holes (7) or other features to allow mounting to a table.

A lock (4) serves to capture the leg (3) in the mounting bracket (2) thereby maintaining the selected height relationship. When used in conjunction with a mounting bracket (2) containing a open sided slot for engagement of the annular grooves (7), the lock (4) may consist of a rotatable hook that can be placed in either of two positions as shown in FIG. 11. In one position, as shown in FIG. 10, the hook will occlude the fork or slot in a manner that prevents the removal of the leg (3) from the slot in the bracket (2). In a different position as shown in FIG. 12, the hook is removed from occluding the fork or slot, allowing the leg (3) to be removed from the mounting bracket (2) as shown in FIG. 11 and re-installed in an alternate annular groove (7) to provide an alternate overall height as is shown in FIG. 13.

FIG. 3 and FIG. 4 show a typical application, in this instance an adjustable accessory table for a sewing machine showing the need for a leg for a low work table that can be easily adjusted for height to suit different sewing machines. FIG. 5, FIG. 6, and FIG. 7 show various conditions of height adjustment. FIG. 5 describes a low setting, dimension “A” while FIG. 6 describes a visibly taller setting, dimension “B”. FIG. 7 shows the leg (3) left out altogether from bracket (2) to allow it to serve as a fixed height leg in very short applications.

The series of annular grooves (6) that are distributed along the length of leg (3) at regular intervals of dimension “A” is asymmetrically positioned within the length of leg (3) as shown in FIG. 14. The distance from the end of leg (3) to the first groove on that end is dimension “B” on one end of the leg (3) and dimension “C” on the other end of leg (3) as shown in FIG. 14. The difference between dimension “B” and dimension “C” is one-half of dimension “A”. When the leg (3) is adjusted within mounting bracket (2), the increments of height adjustment are equal to dimension “A” so far as the same end of leg (3) is maintained as the foot of the leg (3). If the leg (3) is inverted in the bracket such that the other end serves as the foot, the available height settings will be different from the previously mentioned series of height settings by a value of ½ of “A” because of the differing values of “B” and “C”. This is illustrated in FIG. 15 and FIG. 16. For the purpose of discussion, the interval spacing of the grooves, dimension “A”, of the leg (3) in FIG. 15 and FIG. 16 is given a value of ¼″. In the example of FIG. 15, the leg (3) is oriented such that the end associated with dimension “C” serves as the foot of the leg. It is engaged in bracket (2) in the upper most groove for a maximum height setting, in this instance 4⅛″. In the example of FIG. 16, the leg (3) is oriented such that the end associated with dimension “B” serves as the foot of the leg. It is engaged in bracket (2) in the upper most groove for a maximum height setting, in this instance 4¼″ which is ⅛″ taller than the example of FIG. 15. It may be noted that, while the interval of the grooves in leg (3) are, in this example, spaced at ¼″, the actual available increments of height adjustment are ⅛″ or half of the actual groove spacing. This allows for a finer range of adjustment of the height of the assembly without the necessity of making the leg (3) with annular grooves (6) at a spacing “A” that would require more smaller annular grooves (6) positioned at closer intervals.

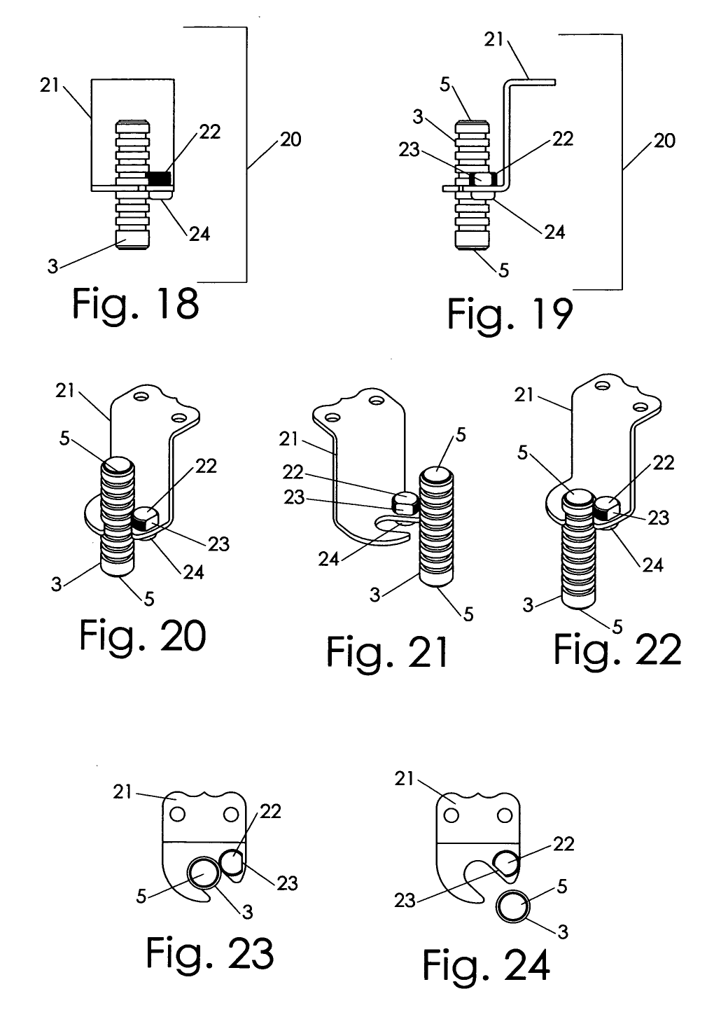

An alternate embodiment of the lock described in the previous paragraphs is shown in FIG. 18 through FIG. 24 where in the function of the lock (4) in the previous embodiment is performed by a rotating lock (22). FIG. 18 describes an adjustable height leg assembly. The mounting bracket (21) is generally similar to the mounting bracket (2) previously described but with changes necessary to accommodate an alternate lock method. The leg (3) is connected to the bracket (21) by engaging one of the annular grooves (6) as described in FIG. 14 in an open sided slot in bracket (21). Positioned rotatably alongside the opening of the slot in bracket (21) is a cylindrical button whose central axis is parallel to the longitudinal axis of the leg (3). One side of the button portion of the rotating lock (22) is cut away to form a flat that is disposed in a plane parallel to the central axis of the rotating lock (22). The rotating lock (22) is able to be rotated about its centerline axis such that either the flat or the opposite side radius may be positioned toward the slot in bracket (21). The position and diameter of the rotating lock is described in FIG. 23, and is such that the radius portion of the rotating lock (22) opposite the flat occludes a portion of the slot. The portion of the slot between the occluded area and the back end of the slot is sufficiently large to accommodate the diameter of the leg (3). The distance between the side of the rotating lock (22) and the opposite side of the slot is insufficient for the diameter of the leg (3) to pass through the restricted portion of the slot. As such, the lock prevents the removal or installation of the leg when the radius of the rotating lock (22) opposite the flat is disposed toward the slot. By turning the rotating lock about its axis, the flat may be disposed toward the slot in the bracket (21). In such orientation, the flat provides sufficient clearance to the opposite side of the slot in bracket (21) that the leg (3) is now able to slide past the formerly occluded area of the slot in bracket (21) and to be installed or removed as displayed in FIGS. 20-24.

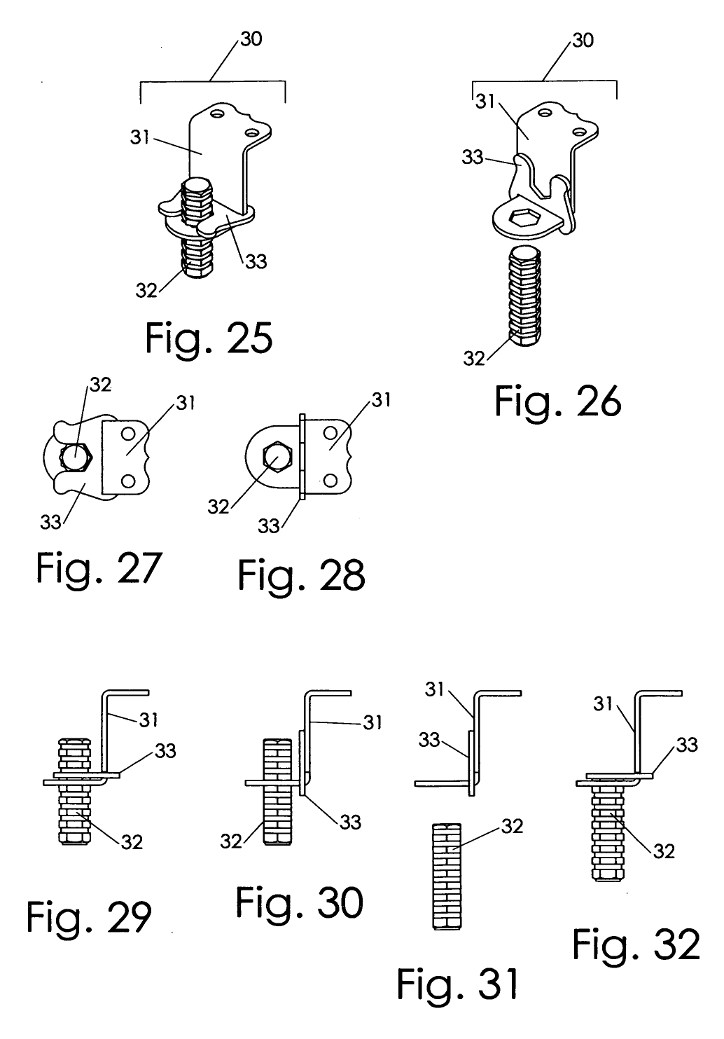

An alternate embodiment of the invention is shown in FIGS. 25-28 wherein a polygonal cross-section leg (32) with a hexagonal or other non-round cross-section and containing a series of annular grooves may be inserted into a hole of like cross-section in the mounting bracket (31). When adjusted longitudinally to align with the annular groove at the desired height, rotating said leg (32) a portion of a turn about its longitudinal axis will place the corners of the hexagon or other irregular feature of the polygonal cross-section leg (32) out of alignment with the corresponding feature of the like hole in the mounting bracket (31) thereby locking said leg in a longitudinal position.

A locking device such as the straddle lock (33) secures the adjustment by preventing additional rotation of the leg about its longitudinal axis and preventing the leg from rotating either direction into alignment with the corresponding hole in the mounting bracket. In the alternate embodiment described in FIG. 25-28, the straddle lock (33) which serves to constrain the leg (32) from rotating is a pivoting plate with a notch that resembles the open end of a wrench as shown in FIG. 25 and FIG. 27. It is flexibly coupled to the mounting bracket (31) such that it may pivot out of engagement with the flats on the sides of polygonal cross-section leg (32) as shown in FIG. 26 and FIG. 28. By pivoting the straddle lock (33) upward as shown in FIGS. 26,28,30, and 31, it is removed from engagement with the polygonal cross-section leg (32) thereby leaving the leg (32) free to rotate about its longitudinal axis in the corresponding like cross section hole in the mounting bracket (31) to a position of rotational alignment where it can slide longitudinally to align with a new groove. Rotating the polygonal cross-section leg (32) out of alignment with the like cross section hole in the mounting bracket (31) in the newly selected groove and returning the straddle lock (33) to a horizontal position wherein it prevents further rotation of the leg (32) serves to secure the adjustment.

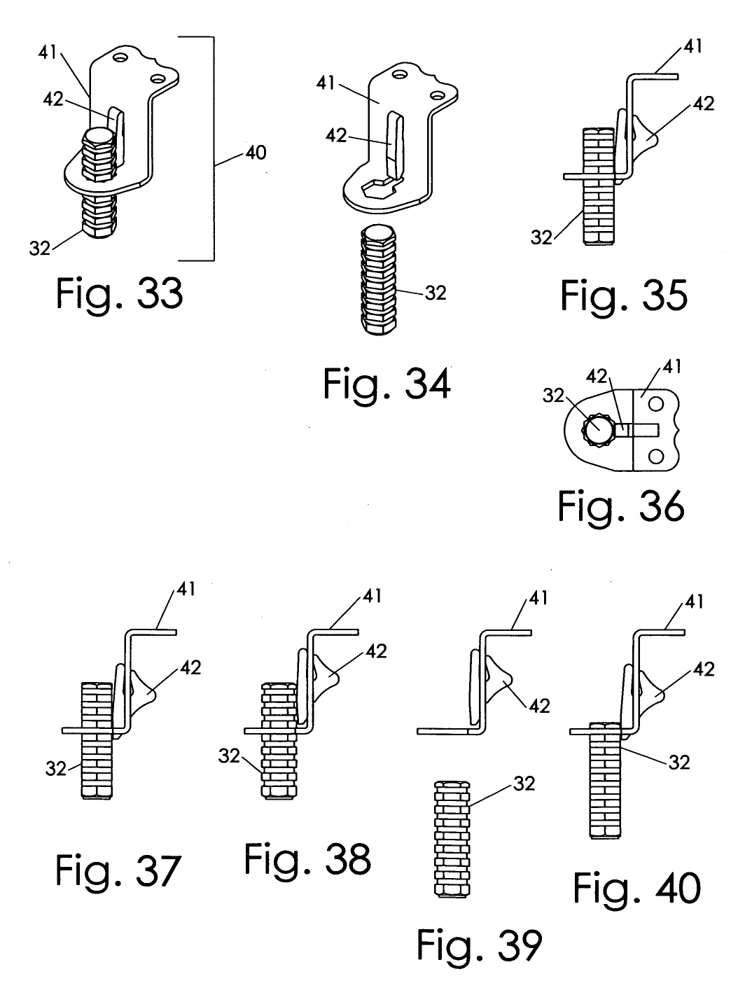

A second alternate embodiment utilizing a polygonal cross-section leg (32) is described in FIG. 33 thru 40. In this embodiment, the lock may consist of a sliding member such as the sliding lock (42) of FIG. 33 that, in one position, engages a corner or irregular feature of the leg and prevents additional rotation of the leg while in another position is disengaged from the corners or irregular features of the polygonal cross-section leg (32) and will allow the leg (32) to rotate about its longitudinal axis and into alignment with the corresponding hole in the mounting bracket (31), allowing the leg (32) to pass longitudinally through the hole in mounting bracket (31) to be set in a new position. In moving from the locked to the unlocked condition, sliding lock (42) moves at a slight angle relative to the axis of the polygonal cross-section leg (32). This has the effect of causing a radial displacement of the face of the sliding lock (42) that engages the feature on the polygonal cross-section leg (32) in a direction away from the longitudinal axis of the polygonal cross-section leg (32). As a result, the sliding lock moves radially to a point where the irregular features of the polygonal cross-section leg (32) can no longer contact the sliding lock (42) and said leg (32) is no longer constrained from rotation about its longitudinal axis thereby allowing the height adjustment as previously described.

In any of the described embodiments, the mounting bracket (2) or (31) or (41) is fastened to the underside of a table or other work surface via bolts, screws, or other suitable method. It may be observed that at the shortest height settings, the upper end of the leg (3) or (31) will approach the plane of the top of the mounting bracket (2) or (31) or (41) and consequently the underside surface plane of the attached tabletop. In general, this is the limit of the length of the leg (3) or (31) that may contain annular grooves (6) and thereby limits the total range of height adjustment. Special applications that allowed the top of the leg (3) or (31) to protrude into or through an opening in the table top or work surface would allow an increase in the range of adjustment so limited.

I claim:

1. An adjustable-length leg for use on tables and like level work surfaces comprising:
A longitudinal member having thereon a repetitive series of circumscribing grooves distributed incrementally along the length of said longitudinal member;
A generally L-shaped mounting bracket having an elongate longitudinal portion that is removeably attachable at a first end thereof to the underside of a table or like work surface and having a transverse portion located at a second end thereof that is opposite to said first end; and connection means disposed at said second end that is adapted to be inserted into a selected one of said grooves and held therein, whereby the effective length of the leg/bracket structure can be given different values, depending upon which one of said grooves into which said connection means is inserted.

2. That adjustable-length leg of claim 1 further comprising:
An orifice through which said longitudinal member can be inserted; and locking means by which said bracket can be held in place within that one of said grooves into which said bracket had been inserted.

3. The adjustable-length leg of claim 2 wherein said locking means comprises an opening in said mounting bracket that exposes that said longitudinal member that had been inserted through said orifice; and a locking arm rotatably attached to said bracket adjacent said opening whereby rotation of said locking arm across said opening will render said longitudinal member no longer exposed, so that the placement of bracket within said one particular groove will fix the effective length of said leg.

4. The adjustable-length leg of claim 1 wherein said longitudinal member has a non-round cross-section and said orifice has the same cross-section pattern as does said longitudinal member, whereby, after said longitudinal member has been placed within said orifice, rotation of said bracket relative to said longitudinal member will preclude any further longitudinal motion of said bracket relative to said longitudinal member, thereby to fix the effective length of said adjustable-length leg.

5. The adjustable-length leg of claim 4 further comprising a sliding lock attached in a slidable manner to said bracket such that one end of said sliding lock faces inward towards said longitudinal member, whereby rotation of said sliding lock relative to said bracket such that said one end come into contact with a flat portion of said longitudinal member any more rotation of said bracket relative to said longitudinal member will be precluded, and said adjustable-length leg will have been given a fixed effective length.
